(19) United States
(12) Patent Application Publication
(10) Pub. No.: US 2014/0198445 A1
(43) Pub. Date: Jul. 17, 2014

(54) Double-sided Keyboard

(71) Applicant: Sze Wai Kwok, Hong Kong (HK)

(72) Inventor: Sze Wai Kwok, Hong Kong (HK)

(21) Appl. No.: 13/890,253

(22) Filed: May 9, 2013

Related U.S. Application Data
(63) Continuation-in-part of application No. 13/744,392, filed on Jan. 17, 2013, now Pat. No. 8,649,164.

(51) Int. Cl. G06F 1/16

(52) U.S. Cl. CPC G06F 1/1669
USPC 361/679.17; 361/679.11

(57) ABSTRACT

A double-sided keyboard comprises a rearward-facing keyboard, a traditional front-facing keyboard and a hinging means. The double-sided keyboard is assembled in a way that the rearward-facing keyboard is on one side of the double-sided keyboard while the traditional front-facing keyboard is on another side of the double-sided keyboard. The hinging means, being on one edge of the double-sided keyboard, is used for connecting to one edge of a tablet computer or mobile computing device, and further provides a sliding mechanism for guiding the sliding motion of the double-sided keyboard. When the double-sized keyboard is attached on to back of a mobile computing device, the rearward-facing keyboard is facing rearward away from the user as the user holds and faces the display screen of the mobile computing device, so that the fingers of the user are free to press the rearward-facing keys on the rearward-facing keyboard. When the double-sided keyboard is slide out, through the sliding mechanism of the hinge, from the back of the mobile computing device, the traditional front-facing keyboard is laid before its user such that the user can type, resembling typing on a laptop computer.

### CROSS-REFERENCE TO RELATED APPLICATION

This application is a continuation-in-part of U.S. patent application Ser. No. 13/744,392 filed Jan. 17, 2013, the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to keyboards and user input interfaces used in computing devices. Specifically, the present invention relates to ergonomic keyboards for mobile computing devices such as tablet computers that can be arranged into various typing positions suitable for high mobility.

BACKGROUND

The modern-day computer keyboards were adapted from the typewriters, which were in existence from as early as the eighteen-hundreds. The most common keyboard layout is the QWERTY keyboard layout. The name comes from the first six letters appearing in the top left row of keys on the keyboard, reading from left to right: Q-W-E-R-T-Y. The QWERTY keyboard layout enables a system of rapid typing. With some degree of training, a user can type without looking at the keys. There are alternative keyboard layouts to the QWERTY keyboard layout, such as the Dvorak Simplified Keyboard. Various keyboard layout adaptations have also been made for non-Latin based languages. Nonetheless, all these keyboard layouts are designed with the same purpose of allowing typing fast and intuitive without the need of visual guidance.

Throughout the years, improvements have been made to the classical keyboard layouts. For example, horizontal tilting with the rows of keys being gradually higher away from the user was introduced with the intention of avoiding the unnatural angling of the hands. Other ergonomic designs include dividing the keys into two partial fields, wherein the rows of keys are parallel to each other in each partial field and the two partial fields are pivoted about a vertical axis such that they are arranged at an angle with regard to each other so that they form a wedge-like shape pointing toward the user. Another design raises the height in between the two aforementioned partial fields causing the two partial fields to tilt outward from the center of the keyboard. The goal is to allow a more natural positioning of the hands and fingers during typing, in turn lessen strain and fatigue of its user.

All of these improvements rest on the premises of that the keyboard is placed before the user and in front of the foot of the display monitor. This fundamental design works well in desktop and laptop computers. However, with the emergence of tablet computers and other mobile computing form factors, the keyboard has become unnecessary and in some cases an impediment to the mobility of these devices. For instance, since the effective operation of the keyboard requires keystrokes made by fingers in both hands, the keyboard must be placed on a surface or be secured hands-free. This works in contradiction to the usage of tablet computers and mobile computing devices that they are often being single-handedly held while the users are roaming around.

However, for substantial amount of textual-type input, such as in the case of composing a long message, the keyboard is still the preferred mechanism. Therefore, there exists an unmet need for a keyboard for tablet computers and mobile computing devices that will not inhibits the mobility of such devices.

### SUMMARY

It is an objective of the presently claimed invention to provide an ergonomic keyboard for tablet computers and mobile computing devices that allows the user to type with both hands naturally while holding the devices at the same time; and optionally to be laid before the user and in front of the devices, resembling the keyboard-screen arrangement of an opened laptop computer.

The presently claimed invention provides a double-sided keyboard comprising a rearward-facing keyboard, a traditional front-facing keyboard and a hinging means. The double-sided keyboard is assembled in a way that the rearward-facing keyboard is on one side of the double-sided keyboard while the traditional front-facing keyboard is on another side of the double-sided keyboard. The hinging means, being installed approximately at one edge of the double-sided keyboard, is used for connecting the double-sided keyboard to one edge of a tablet computer or mobile computing device. The hinging means further includes a sliding mechanism for guiding the sliding motion of the double-sided keyboard at the back of the tablet computer or mobile computing device.

In accordance to one embodiment of the presently claimed invention, the double-sided keyboard is attached on to the back of a tablet computer or mobile computing device. The front of the tablet computer or mobile computing device is the display screen. The double-sided keyboard is attached on to the back of the tablet computer or mobile computing device in a way that the traditional front-facing keyboard is facing and parallel to, or in contact with, the back of the tablet computer or mobile computing device while the reward-facing keyboard are facing rearward away from the user as the user is holding and facing the display screen of the tablet computer or mobile computing device.

When the user holds the tablet computer or mobile computing device with both hands at the bottom or side edges of the tablet computer or mobile computing device, his/her fingers are free to press the rearward-facing keys on the rearward-facing keyboard. The keyboard layout of the rearward-facing keyboard is such that the keys are divided into two partial fields. One partial field contains the keys for the left-hand fingers and the other partial field contains the keys for the right-hand fingers. Then the key arrangements within their respective partial fields is such that the keys are placed in mirror-opposite of the positions that would have been in a front-facing keyboard that is laid before the user. This rearward-facing key orientation allows the user to use the same rapid typing system, such as that of the QWERTY keyboard layout, on the rearward-facing keyboard as he/she would on a traditional front-facing keyboard.

In accordance to various embodiment of the presently claimed invention, the double-sided keyboard is connected to one edge of a tablet computer or mobile computing device by a hinging means. The hinging means further includes a sliding mechanism that allows the double-sided keyboard to slide back and forth so that the double-sided keyboard can be slide out from the back of the tablet computer or mobile computing device, exposing the traditional front-facing keyboard to the user as the user is holding and facing the display screen of the tablet computer or mobile computing device. The hinging means also allows the double-sided keyboard to pivot vertically about the edge of the tablet computer or mobile computing device once the double-sided keyboard is slide out from the back of the tablet computer or mobile computing device, resembling the keyboard-screen arrangement of an opened laptop computer. In this position, the traditional front-facing keyboard is laid before and facing to the user while the rearward-facing keyboard is facing downward or being in contact with a supporting surface. The key orientation or layout of the traditional front-facing keyboard can be that of any rapid typing system, such as that of the QWERTY keyboard layout.

Hence the user can choose to type with either the reward-facing keyboard when placing the double-sided keyboard on the back of the tablet computer or mobile computing device, or the traditional front-facing keyboard when slide out from the back of the tablet computer or mobile computing device.

In accordance to various embodiments of the presently claimed invention, the hinging means further includes a locking mechanism for adjusting and fixing the orientation of the tablet computer or mobile computing device at various pivoting angles between the double-sided keyboard and the tablet computer or mobile computing device when typing with the traditional front-facing keyboard.

In accordance to various embodiments of the presently claimed invention, the double-sided keyboard can be a built-in feature of a tablet computer or mobile computing device, or a detachable ancillary peripheral to a tablet computer or mobile computing device.

In accordance to various embodiments of the presently claimed invention, the keys of the rearward-facing keyboard and/or the keys of the traditional front-facing keyboard are mechanical tactile keys, touch sensing keys, or combination thereof

### BRIEF DESCRIPTION OF THE DRAWINGS

Embodiments of the invention are described in more detail hereinafter with reference to the drawings, in which:

FIG. 1 shows a diagram illustrating a double-sided keyboard that is attached to the back of a tablet computer and being held by both hands of a user in a rearward-typing position in accordance to one embodiment of the presently claimed invention;

FIG. 2 shows a diagram illustrating a double-sided keyboard that is hinge-connected to one edge of a tablet computer and slide out from back of the tablet computer, exposing the traditional front-facing keyboard to the user as the user is holding and facing the display screen of the tablet computer or mobile computing device, in accordance to one embodiment of the presently claimed invention; and

FIG. 3 shows a diagram illustrating a double-sided keyboard that is slide into a traditional front-facing position with a traditional front-facing keyboard facing to a user, resembling the keyboard-screen arrangement of an opened laptop computer, in accordance to one embodiment of the presently claimed invention.

### DETAILED DESCRIPTION

In the following description, apparatuses for facilitating user keystroke input and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

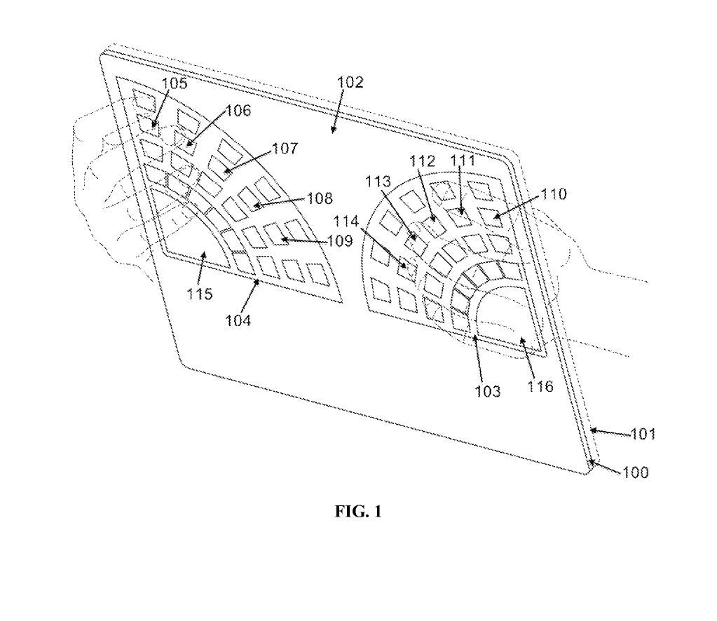

Referring to FIG. 1. In accordance to one embodiment of the presently claimed invention, a double-sided keyboard 100, comprising a rearward-facing keyboard 102, a traditional front-facing keyboard and a hinge (both are not shown in FIG. 1), is attached on to the back of a tablet computer or mobile computing device 101. The hinge is used for connecting to one edge of tablet computer or mobile computing device 101. The front of the tablet computer or mobile computing device 101 is the display screen. The double-sided keyboard 100 is attached on to the back of the tablet computer or mobile computing device 101 in a way that the traditional front-facing keyboard is facing and parallel to, or in contact with, the back of the tablet computer or mobile computing device 101 while the keys of the rearward-facing keyboard are facing rearward away from the user as the user is holding and facing the display screen of the tablet computer or mobile computing device 101.

When the user holds the tablet computer or mobile computing device with both hands at the bottom or the two side edges of the tablet computer or mobile computing device 101, his/her fingers are free to press the rearward facing keys of the rearward-facing keyboard 102. The keyboard layout of the rearward-facing keyboard is such that the keys are divided into two partial fields 103 and 104. The partial field 103 contains the keys for the left-hand fingers and the partial field 104 contains the keys for the right-hand fingers. Then the key arrangements within their respective partial fields is such that the keys are placed in mirror-opposite of the positions that they would have been in a front-facing keyboard that is laid before the user. This rearward facing key orientation allows the user to use the same rapid typing system, such as that of the QWERTY keyboard layout, on the rearward-facing keyboard as he/she would on a traditional front-facing keyboard.

To illustrate this mirror-opposite orientation of the QWERTY keyboard layout, as shown in FIG. 1, key 105 is for the letter “Y”, key 106 is for the letter “U”, key 107 is for the letter “I”, key 108 is for the letter “0”, key 109 is for the letter “P”, key 110 is for the letter “T”, key 111 is for the letter “R”, key 112 is for the letter “E”, key 113 is for the letter “W”, and key 114 is for the letter “Q”. Keys 115 and 116 are the space bars. Other letter, number, and symbol keys are then placed at their respective positions accordingly.

In accordance to various embodiments of the presently claimed invention, the double-sided keyboard can be a built-in feature of the tablet computer or mobile computing device or a detachable ancillary peripheral to the tablet computer or mobile computing device. In the case of a detachable peripheral, the double-sized keyboard can be electrically connected to the tablet computer or mobile computing device for data signal exchanges through wired communication link conforming to one or more industrial standards such as the Universal Serial Bus (USB) and IEEE 1394 standards. The electrical connection can also be made through wireless communication link conforming to one or more industrial standards such as the Wi-Fi and Bluetooth standards. Other wired and wireless communication protocols can also be adopted without undue experiment and be prepared by practitioners skilled in the electronic art based on the teachings of the present disclosure.

In accordance to another embodiment of the presently claimed invention, the rows of keys within each of the partial fields curve to form parallel arcs such that each partial field of keys proximately resembles a quarter slice of a circle. The curve of each partial field faces the inner top of the keyboard. This keyboard layout enhances the ergonomics of the rearward-facing keyboard by matching closely to the natural positions of the fingers and angling of the hands while holding the tablet computer or mobile computing device and typing on the rearward-facing keyboard.

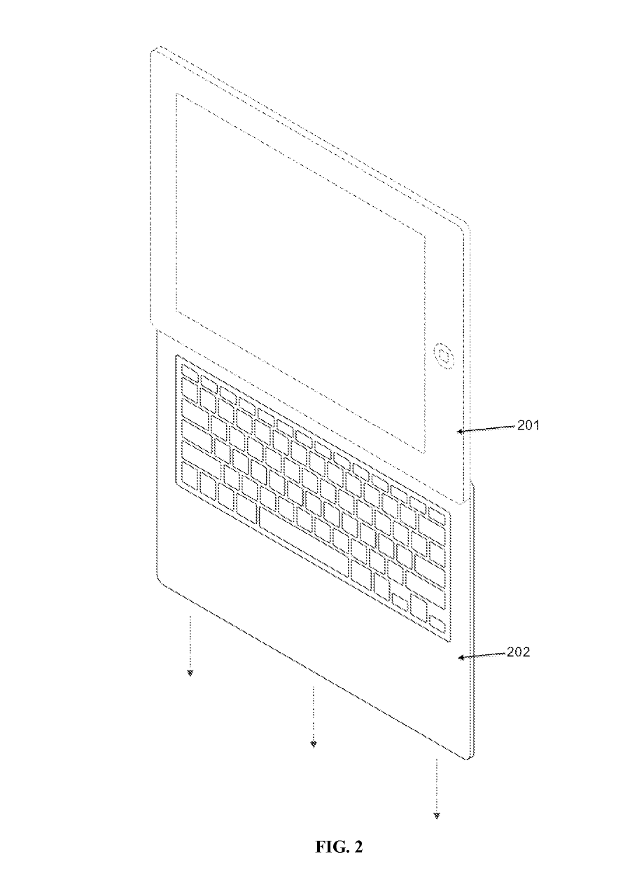

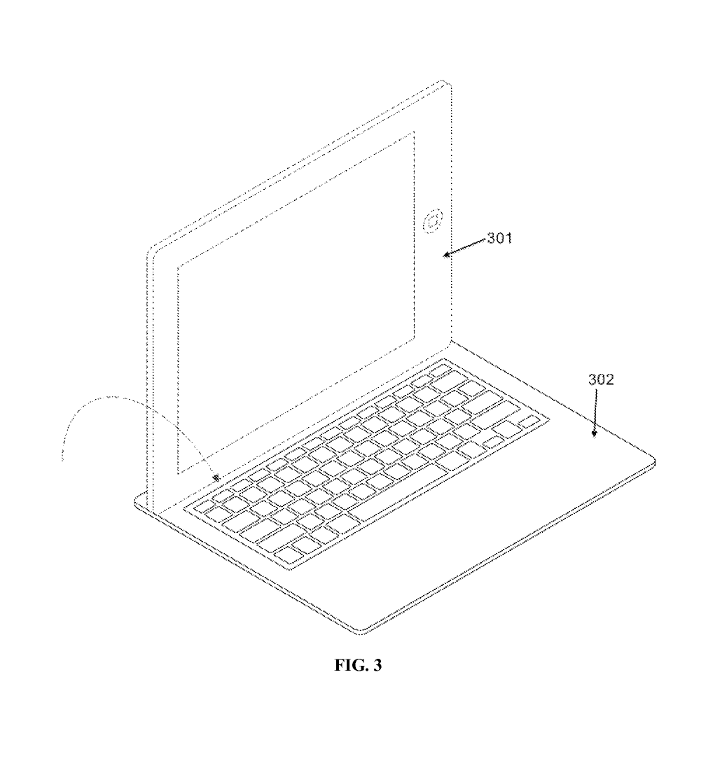

Referring to FIG. 2 and FIG. 3. In accordance to another embodiment of the presently claimed invention, the double-sided keyboard 202 can be slide out, through a sliding mechanism of a hinging means (not shown in FIG. 2 and FIG. 3), from the back of the tablet computer or mobile computing device 201, exposing the traditional front-facing keyboard to the user as the user is holding and facing the display screen of the tablet computer or mobile computing device, as shown in FIG. 2. As shown in FIG. 3, the hinging means also allows the double-sided keyboard 302 to pivot vertically about the edge of the tablet computer or mobile computing device 301 once the double-sided keyboard 302 is slide out from the back of the tablet computer or mobile computing device 301, resembling the keyboard-screen arrangement of an opened laptop computer. In this position, the traditional front-facing keyboard is laid before and facing to the user while the rearward-facing keyboard is facing downward or being in contact with a supporting surface. The key orientation or layout of the traditional front-facing keyboard can be that of any rapid typing system, such as that of the QWERTY keyboard layout.

In accordance to various embodiments of the presently claimed invention, the hinging means includes a sliding mechanism, which guides the sliding motion of the double-sided keyboard to allow the double-sided keyboard to slide back and forth so that the double-sided keyboard can slide in and out from the back of the tablet computer or mobile computing device. Hence the user can choose to type with either the reward-facing keyboard when placing the double-sided keyboard on the back of the tablet computer or mobile computing device, or the traditional front-facing keyboard when slide out from the back of the tablet computer or mobile computing device.

In accordance to one embodiment of the presently claimed invention, the sliding mechanism of the hinging means comprises a base, a sliding frame, and a rail device. The base is installed on the hinging means. The sliding frame is installed on the double-sided keyboard. The rail device, installed between the base and the sliding frame, is for the sliding frame to slide along the rail device. However, other sliding mechanisms can also be adopted without undue experiment and be prepared by practitioners skilled in the mechanic art based on the teachings of the present disclosure.

In accordance to various embodiments of the presently claimed invention, the hinging means further includes a locking mechanism for adjusting and fixing the orientation of the tablet computer or mobile computing device at various pivoting angles between the double-sided keyboard and the tablet computer or mobile computing device when typing with the traditional front-facing keyboard in order to meet the need of the user.

In accordance to various embodiments of the presently claimed invention, the keys of the rearward-facing keyboard can be mechanical tactile keys, touch sensing keys, or combination thereof. Similarly, the keys of the traditional front-facing keyboard can be mechanical tactile keys, touch sensing keys, or combination thereof. In accordance to various embodiments, the keys can also be reassigned with different letters, numbers, and symbols through software and/or hardware configuration during assembly or during usage runtime.

Although the present invention is being primarily described in association with the QWERTY keyboard layout, the present invention can be adapted without undue experimentation and similarly be applied to other keyboard layouts including non-Latin based language keyboard layouts.

The aforementioned tablet computers and mobile computing devices can be any commercially available devices including, but are not limited to, the Apple® iPad®, Apple® iPhone®, Samsung® Galaxy®, and Amazon® Kindle®.

The embodiments disclosed herein may be implemented using a combination of electro-mechanical assembly of keys and buttons and a general purpose or specialized computing device, computer processor, or electronic circuitry including but not limited to a digital signal processor (DSP), application specific integrated circuit (ASIC), a field programmable gate array (FPGA), and other programmable logic device configured or programmed according to the teachings of the present disclosure. Computer instructions or software codes running in the general purpose or specialized computing device, computer processor, or programmable logic device can readily be prepared by practitioners skilled in the electronic art based on the teachings of the present disclosure.

The foregoing description of the present invention has been provided for the purposes of illustration and description. It is not intended to be exhaustive or to limit the invention to the precise forms disclosed. Many modifications and variations will be apparent to practitioners skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A double-sided keyboard for a mobile computing device, comprising:
a rearward-facing keyboard being on one side of the double-sided keyboard; and
a traditional front-facing keyboard being on another side of the double-sided keyboard;
wherein the double-sided keyboard being attached on to the back of the mobile computing device.

2. The double-sided keyboard of claim 1, further comprising
a hinging means being connected to one edge of the mobile computing device, wherein the hinging means comprises a sliding mechanism to guide the sliding motion of the double-sided keyboard in and out from back of the mobile computing device;

3. The double-sided keyboard of claim 1, wherein the double-sided keyboard being arranged in one of arrangements including:
that the traditional front-facing keyboard is facing the back of the mobile computing device while the keys on the rearward-facing keyboard are facing rearward away from its user as the user holds and faces front of the mobile computing device;
that the double-sided keyboard being slide out from the back of the mobile computing device, exposing the traditional front-facing keyboard to its user; and
that the double-sided keyboard being slide out from the back of the mobile computing device and pivot vertically about the edge of the mobile computing device such that the traditional front-facing keyboard being laid before its user.

4. The double-sided keyboard of claim 1, wherein the rearward-facing keyboard comprising:
a first partial field of keys, comprising a first group of keys for left-hand fingers, wherein the first group of keys is arranged such that the keys are placed in mirror-opposite of positions that they would have been in a front-facing keyboard; and
a second partial field of keys, comprising a second group keys for right-hand, wherein the second group of keys is arranged such that the keys are placed in mirror-opposite of positions that they would have been in a front-facing keyboard fingers.

5. The double-sided keyboard of claim 1, wherein the double-sided keyboard being a detachable ancillary peripheral to the mobile computing device.

6. The double-sided keyboard of claim 1, wherein the double-sided keyboard being a built-in feature of the mobile computing device.

7. The double-sided keyboard of claim 1, wherein the rearward-facing keyboard having a QWERTY keyboard layout.

8. The double-sided keyboard of claim 1, wherein the traditional front-facing keyboard having a QWERTY keyboard layout.

9. The double-sided keyboard of claim 1, wherein the keys of the rearward-facing keyboard and/or the traditional front-facing keyboard being mechanical tactile keys.

10. The double-sided keyboard of claim 1, wherein the keys of the rearward-facing keyboard and/or the traditional front-facing keyboard being touch sensing keys.

11. The double-sided keyboard of claim 1, wherein letter, number, and symbol assignments of the keys of the rearward-facing keyboard and/or the traditional front-facing keyboard being configurable.

12. The double-sided keyboard of claim 2, wherein the hinging means having a locking mechanism for adjusting and fixing the orientation of the mobile computing device.
